(19) United States
(12) Patent Application Publication
(10) Pub. No.: US 2009/0151627 A1
(43) Pub. Date: Jun. 18, 2009

(54) Paint edger and trimmer

(76) Inventor: Glenn Summerfeild, Manasquan, NJ (US)

Correspondence Address: CLIFFORD G. GRAYNE, Suite 7A, 136 Drum Point Road, Brick, NJ, 08723, US

(21) Appl. No.: 12/290,451

(22) Filed: Oct. 31, 2008

Related U.S. Application Data
(60) Provisional application No. 61/007,799, filed on Dec. 17, 2007.

(51) Int. Cl. B05C 1/06

(52) U.S. Cl. 118/264

(57) ABSTRACT

An edger/trimmer of two-piece construction having a foam painting pad secured to a large outer face of an L-shaped frame from the back of which extends a handle plate. The short section of the L-shaped frame serves as the guide, which contacts the abutting surface and provides smooth, straight movement of the pad along the surface to be painted. The pad and guide are uniquely designed and configured so that nearly all facets of edging and trimming can be easily, quickly and accurately accomplished.

### RELATED APPLICATIONS

Applicant claims the benefit of provisional application Ser. No. 61,007,799, filed Dec. 17, 2007.

### BACKGROUND OF THE INVENTION

1. Field of the Invention

The present invention relates to paint application implements, and in particular, the present invention relates to pad type implements used to apply paint to the edges around ceilings, doors, windows, and trim, and also to the trim pieces themselves.

2. Description of the Prior Art

While the majority of wall painting is done with rollers, the edging and trimming has always remained a difficult task. As an alternative to using a brush, which normally requires a high level of skill, a myriad of edging and trimming pads has been developed. However, as with a brush, difficulty still remains when attempting to paint straight lines along the edges of a wall or ceiling, around door and window trim, or to accurately paint the trim and molding pieces themselves. In order to achieve a neat, acceptable appearance, the lines must be straight and the painting must be done without contacting the adjacent walls or trim. Also, the painting must be done without flooding the corners with excess paint, which results in a sloppy finish.

One major drawback to most common edger and trimmer pads is in the design of the standoff guides upon which they rely. Some of the pads employ integral rollers, which contact the abutting surface. These roller systems are generally complicated and expensive to manufacture. They are also easily fouled with paint and are difficult to clean.

Other pads employ planar or angular movable guide plates, which are intended to abut the adjacent surface and are pulled away when the pad in dipped into the paint. These movable plates are generally expensive to manufacture, difficult to use and are too easily fouled with paint.

Still other pads employ fixed, planar guide plates which also serve as the pad attachment frame. These generally provide only a very thin contacting edge with the abutting surface, which tends to be unreliable in that the pad can easily tilt, resulting in an uneven application of paint. These pads also perform poorly when used on trim and molding. In addition, these pads do not account for paint buildup along the edge of the pad which will constantly foul the contacting edge of the guide.

Many other painting pads have no guide at all and would require an extremely high level of skill if used for close edging or for painting molding. These pads are generally useful only for rough work.

Another major drawback to most common edger and trimmer pads is the type and orientation of the absorbent pad itself. The short, flexible bristle pads which most of the edgers employ have a built-in flaw, which is the unpredictable position of these bristles due to their natural flexing action. This often results in crooked lines in addition to likely flooding of the corners. One edger employs a foam pad and has a planar guide which is very thin and will easily be fouled with paint. This edger is not useful on molding and makes no accommodation for painting into corners, although this seems to be the main claim of this edger.

Relevant prior art discussed heretofore include U.S. Pat. No. 3,708,821 to Chase; U.S. Pat. No. 5,495,635 to Williams; U.S. Pat. No. 2,985,902 to Sopocy; U.S. Pat. No. 5,209,781 to Milkie; U.S. Pat. No. 3,359,589 to Moore; U.S. Pat. No. 2,810,148 to Wood; U.S. Pat. No. 2,853,731 to Lancaster; U.S. Pat. No. 5,331,710 to Tollasepp; U.S. Pat. No. 4,155,140 to Janssen; U.S. Pat. No. 3,117,334 to Imhof; U.S. Pat. No. 4,127,911 to Cupp; U.S. Pat. No. 5,678,277 to Sorenson; U.S. Pat. No. 2,156,270 to Smith; U.S. Pat. No. 4,134,173 to Cupp; U.S. Pat. No. 5,267,369 to O'Neil; U.S. Pat. No. 4,674,144 to Palmeri; U.S. Pat. No. 3,464,079 to Palmeri; U.S. Pat. No. 3,728,755 to Whalen; U.S. Pat. No. 5,933,905 to Hess; U.S. Pat. No. 5,134,745 to Burns; U.S. Pat. No. 3,172,140 to Burns; U.S. Pat. No. 4,658,461 to Magnien; U.S. Pat. No. 4,658,461 to Roe; U.S. Pat. No. 3,484,795 to Nicolay; U.S. Pat. No. 3,473,183 to Burns; U.S. Pat. No. 4,852,203 to LaBelle; U.S. Pat. No. 3,771,190 to Tischler; U.S. Pat. No. 4,300,258 to Burns; U.S. Pat. No. 3,414,929 to Warner; U.S. Pat. No. 4,819,294 to Calvert; U.S. Pat. No. 7,028,363 to Gartner; U.S. Pat. No. D439,748 to Woodnorth; U.S. Pat. No. 3,388,415 to Warner.

Applicant's novel contribution to the art addresses the shortcomings of the prior art pads and introduces a unique, simple and effective design edger/trimmer which accomplishes all the necessary edging and trimming tasks with the least amount of skill required of the user. Applicant's edger/trimmer also has application to hard to reach corners between walls, especially at ceiling junctures. Applicant's edger/trimmer also has application not only to wall edging, but also performs extremely well when painting various trim and molding. It is also simple to manufacture and easy to clean.

### OBJECTS OF THE INVENTION

An object of the present invention is to provide for a novel edger/trimmer which will paint accurate, straight lines on walls, where walls abut ceilings, and on walls around doors, windows and other various types of molding.

A still further object of the present invention is to provide for a novel edger/trimmer which will paint into corners where two adjacent walls meet, especially at ceiling junctures.

A still further object of the present invention is to provide for a novel edger/trimmer which can also be used to accurately paint trim and molding pieces such as casings, baseboards, chair rails and window mullions.

A still further object of the present invention is to provide for a novel edger/trimmer which will paint into corners where mullions or other types of moldings meet at 90 degree angles.

A still further object of the present invention is to provide for a novel edger/trimmer which will accurately paint the narrow sides of door or window casings where these sides abut wall surfaces.

A still further object of the present invention is to provide for a novel edger/trimmer which will accurately paint the thin edges found on trim such as baseboards and chair rails where these edges abut wall surfaces.

A still further object of the present invention is to provide for a novel edger/trimmer which will absorbs excess paint from the pressure of application back into the pad, which avoids flooding of corners and fouling of the edger's guide.

A still further object of the present invention is to provide for a novel edger/trimmer which is simple and inexpensive to manufacture, easy to use, easy to clean, reusable, requires less skill and performs more accurately than those represented by the prior art.

### SUMMARY OF THE INVENTION

An edger/trimmer of two-piece construction having a foam painting pad secured to a large outer face of an L-shaped frame from the back of which extends a handle plate. The short section of the L-shaped frame serves as the guide, which contacts the abutting surface and provides smooth, straight movement of the pad along the surface to be painted. The pad and guide are uniquely designed and configured so that nearly all facets of edging and trimming can be easily, quickly and accurately accomplished.

### BRIEF DESCRIPTION OF THE DRAWINGS

These and other objects of the present invention will become apparent, particularly in light of the following illustrations wherein:

FIG. 1 is a side view of the edger/trimmer of the present invention;

FIG. 2 is a rear view of the edger/trimmer of the present invention;

FIG. 3 is a rear view of the invention illustrating a second embodiment of a handle or gripping means;

FIG. 4 is a view of the invention applying paint to a wall near a ceiling and into the corner where two adjacent walls meet at a ceiling juncture; and

FIG. 5 is a view of the invention applying paint on a mullion and into a corner where two mullions meet around a window glass.

### DETAILED DESCRIPTION OF THE INVENTION

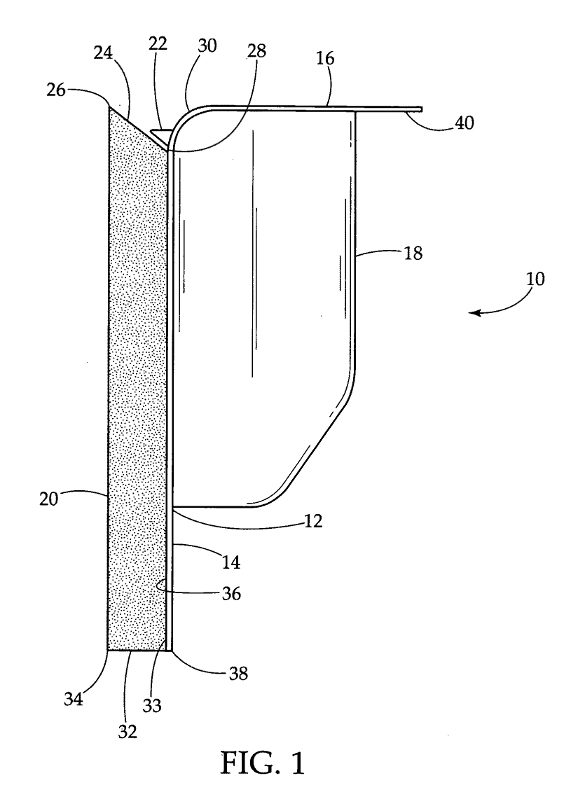

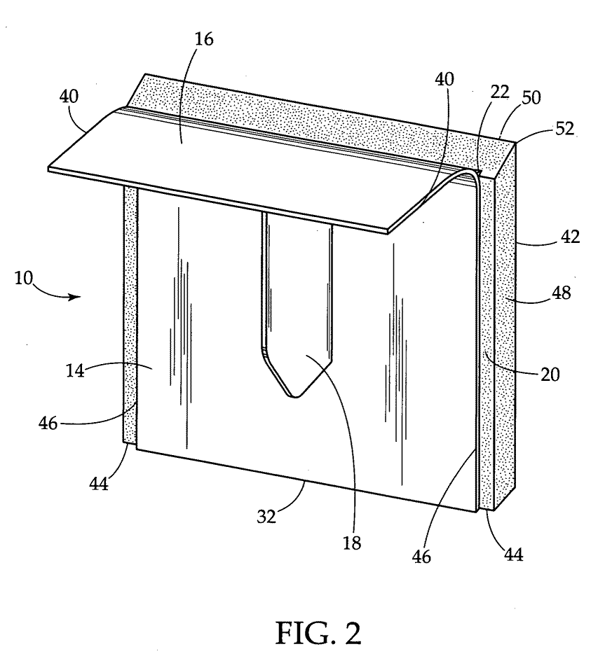

FIGS. 1 and 2 are side and back views of paint edger/trimmer 10 which comprises a one-piece, L-shaped, molded plastic frame 12 whose larger section is backing plate 14 to which pad 20 is securely attached to outer face 36. The smaller section of the frame is guide plate 16, which extends at a 90 degree angle from backing plate 14 and serves as a guide which contacts and slides along the adjacent surface (wall, trim or glass), which is not to be painted.

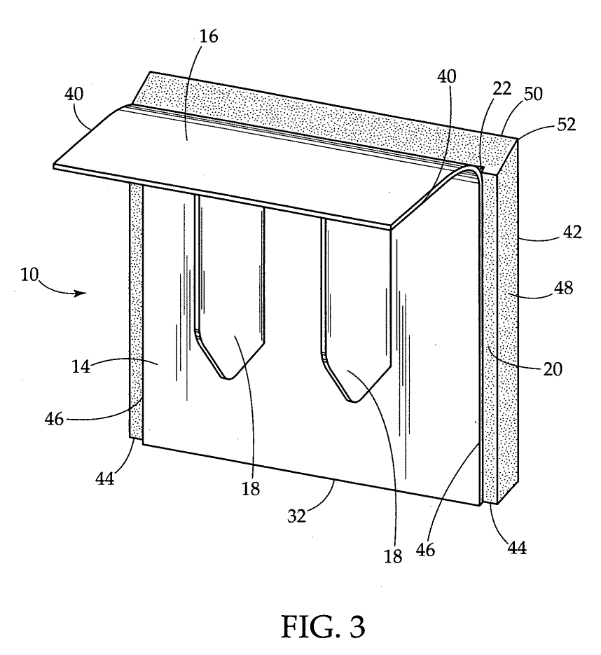

Left and right ends of guide plate 16 are arcuate 40 to provide ease of movement across the unpainted adjacent surface. Handle plate 18 is integrally molded into the frame 12 of edger 10 and extends at a 90 degree angle along the centers measured from left to right of the inside edges of both plates 14 and 16. A handle plate 18 provides the gripping surface for the edger and also serves to stabilize plates 14 and 16 so that a 90 degree position between these two plates is maintained. FIG. 3 illustrates a second embodiment of the handle plate 18 which comprises two spaced apart handle plates which allow for more comfortable gripping of the edger.

Painting pad 20 is made of polyurethane foam and is attached at its back, inside surface 33 by means of a securing means such as glue or the like to outer face 36 of backing plate 14. Pad 20 is approximately 5/16 inch thick from inside surface 33 to outside surface 34.

Pad 20 is square or slightly rectangular in nature and extends vertically from its bottom 32 at the bottom 38 of plate 14 to the bottom of triangular ridge 22. The two projecting sides of triangular ridge 22 are approximately 1/32 inch long. Ridge 22 extends the entire width of the outer face 36 of plate 14 and is located approximately ⅛ inch below the plane of the top of plate 16. The top side of ridge 22 projects at a 90 degree angle from plate 14. The bottom of ridge 22 projects at an approximately 30 degree angle downward from the top side of ridge 22 and terminates approximately 3/16 inch below the plane of the top of plate 16. The bottom, angled side of ridge 22 provides a guide for precise positioning pad 20 when it is secured to plate 14.

The top of pad 20 has an approximately 30 degree bevel 24 extending from outer plane 26 to inner plane 28. The juncture between plates 14 and 16 has curved area 30 which, along with bevel 24, produces a void which allows excess paint to collect and be reabsorbed into pad 20. This void performs the vital function of keeping paint from contacting the adjacent surface and from fouling the outer/contacting surface of plate 16.

While the entire outer surface 34 of pad 20 is used to apply paint, the uppermost corner 50 which extends between left corner 26 and right corners 52, produces the close straight lines, i.e. edging or “cutting in” as it is called in the trade. The top of edge 50 terminates in height 1/32 inch below the plane of the top of plate 16. This 1/32 inch clearance keeps paint from flooding the corners between adjacent walls or between trim pieces and abutting surfaces. This clearance also reduces the chance that the pad and paint will contact adjacent surfaces which are not to be painted.

Due to excess pressure by the user, paint may accumulate along ridge 22 and curved area 30. This accumulation does not affect the overall performance of the edger and any paint which is not reabsorbed back into the pad can be periodically wiped away. This achieves the important result of keeping the straight/contacting area of plate 16 from becoming fouled with paint.

Pad 20 extends beyond the edges 46 of plate 14, forming overlaps 44, which extend approximately ⅛ inch to the left and right of the edges 46 of plate 14. Overlaps 18, and in particular the extreme ends of pad 20 at left and right sides 48, left and right corners 42, and left and right corners 26 and 52, allow for painting fully into corners where two adjacent walls meet, especially at ceiling junctures, and for painting into corners where mullions or other trim or molding pieces meet at 90 degree or similar angles. Without this overlap feature, a separate fine brush would be needed to paint such corners.

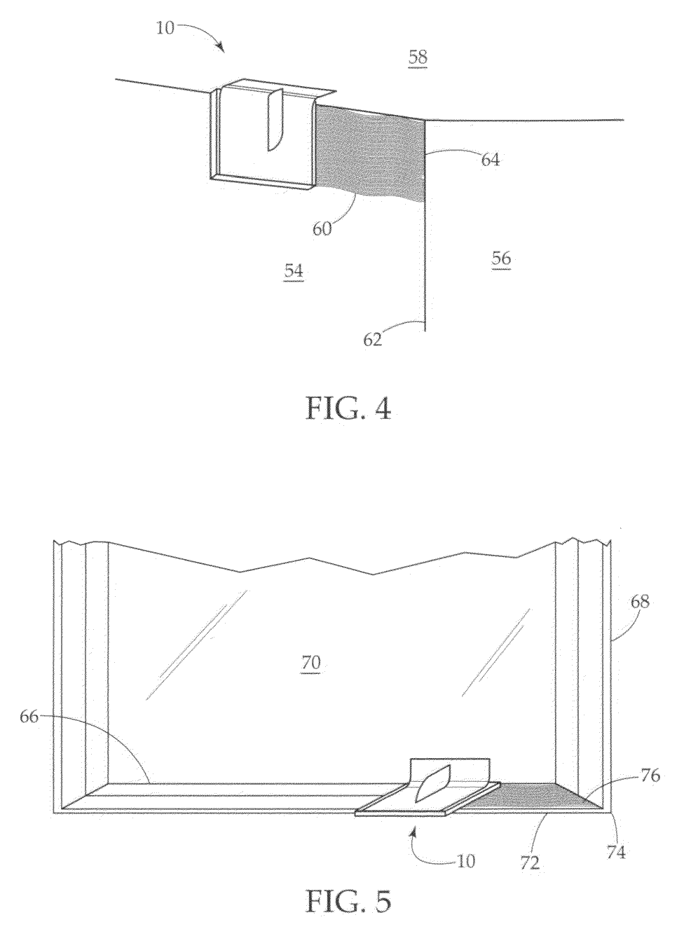

FIG. 4 is a view of the corner where two walls 54 and 56 meet at a juncture with ceiling 58. Edger 10 is positioned along wall 54 with plate 16 abutting ceiling 58 and is shown applying paint to wall 54 as depicted by shaded area 60. The application of paint fully into corner 62 is depicted by shaded area 64 on wall 56 which is accomplished due to overlap 44 of pad 20.

FIG. 5 is a view of mullions 66 and 68 constructed around the perimeter of window glass 70. Edger 10 is positioned along mullion 66 with plate 16 abutting glass 70 and is shown applying paint to mullion 66 as depicted by shaded area 72. The application of paint fully into corner 74 is depicted by shaded area 76.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. A paint edger and trimmer for the application of paint to a surface at a location where said surface intersects an adjacent surface, the paint edger and trimmer comprising:
an L-shaped frame in cross-section, one leg of said frame serving as a backing plate having a contact face and a rear face, a second leg, integral with said first leg backing plate, said second leg comprising a guide plate having a contact face and a rear face formed in 90 degree relationship with said backing plate and integral therewith, there being integrally formed and secured to the rear face of said guide plate and said rear surface of said backing plate, a handle member for gripping and moving said paint edger and trimmer;
a positioning member positioned transversely on said rear surface of said backing plate, said positioning member serving as a guide for positioning a painting pad;
a painting pad formed of an absorbent foam having a planar first side and a planar second side and two side walls and a lower end wall perpendicular to said first and second planar sides and an upper end wall having a beveled edge extending away from said backing plate from said planar first side to said planar second side, said planar first side of painting pad secured to said contact face of said backing plate.

2. A paint edger and trimmer in accordance with claim 1 wherein said beveled edge terminates below a plane of said guide plate.

3. A paint edger and trimmer in accordance with claim 1 wherein a void formed between said upper beveled edge of said painting pad and said backing plate allows collection and reabsorbancy of excess paint into said paint pad and prevent paint migration to said contact face of said guide plate.

4. The paint edger and trimmer in accordance with claim 1 wherein said positioning member comprises a transverse rib positioned along the lower edge of said backing plate.

5. The paint edger and trimmer in accordance with claim 1 wherein said positioning member comprises a transverse rib positioned at the terminus of a planar portion of said backing plate at its upper end.

6. A paint edger and trimmer in accordance with claim 1 wherein said positioning member is positioned transversely on said rear face of said backing plate intermediate said lower edge and said upper planar terminus.
